(19) United States
(12) Patent Application Publication
(10) Pub. No.: US 2014/0139467 A1
(43) Pub. Date: May 22, 2014

(54) VCSEL Sourced Touch Screen Sensor Systems

(71) Applicant: Princeton Optronics Inc., Mercerville, NJ (US)

(72) Inventors: Chuni L. Ghosh, Princeton Junction, NJ (US); Jean-Francois Seurin, Princeton Junction, NJ (US); Laurence S. Watkins, Pennington, NJ (US)

(73) Assignee: Princeton Optronics Inc., Mercerville, NJ (US)

(21) Appl. No.: 14/085,775

(22) Filed: Nov. 20, 2013

Related U.S. Application Data
(60) Provisional application No. 61/729,000, filed on Nov. 21, 2012.

(51) Int. Cl. G06F 3/041

(52) U.S. Cl. CPC G06F 3/0416
USPC 345/173

(57) ABSTRACT

Touch screen sensor systems that incorporate VCSELs or VCSEL arrays to provide illumination beams for sensing the position of objects such as a finger or stylus in a two dimensional space is provided. Normally the touch sensor is used with a display screen so that objects in the display screen are identified by positioning a finger or stylus at the object's position. The invention describes improved illumination methods using VCSELs that realize higher resolution in position sensing. VCSELs can also be integrated with detectors on a common substrate which provides both illumination and detection functions for the touch sensor system. Different methods to suitably couple light from VCSEL arrays directly, or through guided light paths such as fibers and waveguide arrays are provided to configure a touch sensor in different applications.

### CROSS REFERENCE TO RELATED APPLICATION:

This application claims priority from the U.S. Provisional Application No. 61/729,000 filed on Nov. 21, 2012, the content of which is being incorporated by reference in its entirety.

### BACKGROUND OF THE INVENTION:

1. Field of the Invention

This invention is in the field of interactive input device and in particular, to an interactive touch screen as an input means for an electronic display of a stationary computer, display panel, or a portable device such as a laptop computer, a tablet, electronic book reader, smartphones, personal digital assistant (PDA), Global Positioning System (GPS) etc., where a user input is provided interactively on a display screen using a finger, a pen or a stylus.

2. Relevant Background Art

Early touch screen devices have been constructed for a cathode ray tube (CRT) display screen particularly to place a cursor for selecting a specific display or an image. A device described in the U.S. Pat. No. 3,478,220 issued to Milroy on Nov. 11, 1969 discloses positioning a cursor on the screen of a CRT in response to a touch of a finger on a control grid. More specifically, the control grid comprises an array of radiant energy sources and one or more radiation sensors to detect/measure the energy from the energy sources. Interruption in energy flow between one or more energy sources and sensor pair is used to provide an output signal to position a cursor on the CRT.

Typically, a panel including a plurality of sources for example light sources, are mounted on two adjacent edge of the panel such that a grid of light is generated over a CRT display, as disclosed in the U.S. Pat. No. 3,673,327 issued to Johnson et al. on Jun. 27, 1972. Corresponding sets of detectors are provided on respective opposite edges. The position of an object for example, a finger, pen or stylus is determined by the x-y coordinates of the respective detector positions on the grid where a light interruption is detected. The signal or loss of signal in specific detectors is then processed using a processor to generate control signals for various operations required for using the information for further action.

In recent times, touch screen input means (touch screen in short) are particularly used in conjunction with interactive display devices where a user input is needed to provide a prompt on a display screen for specific device operation for example, a response to a visual prompt, select an option, draw, drag & drop, transfer, share, enter data, etc. In the most common form, a touch screen input is provided by a probe for example, a finger, pen, stylus, etc. on a platen which may be the display screen itself, or a flat transparent overlay on the display screen of a device. Electronic devices that widely use a touch screen. Some of the common devices that use touch screen input include portable computer, tablet, electronic book reader, smartphone, PDA, GPS, just to name a few. Other devices that use touch screen are ATM, ticketing machines, electronic menu in a cash register, etc.

There are different ways of configuring a touch screen. A typical touch screen comprises a touch panel including one or more light source and corresponding one or more sensor or detector to receive the light transmitted by said source. One type of a touch panel comprises a thin planar transparent panel disposed over a display screen. The thickness of the transparent panel is selected such that the display screen is visible through the touch screen. The light source transmits light and a user initiated touch event results in blocking or scattering the light. The position of the blocked or scattered light determines the touch position by sampling appropriate detectors. In another type of touch screen, a thin sheet of light is transmitted or projected in free space above the display screen where a touch event disrupts the transmission which can be detected as blocked or scattered light.

An electrical signal generated proportional to the detector response is correlated to the position of the user initiated touch event on the screen by signal processing. Typically, the light source and detectors of the touch panel are located under a frame disposed on the display screen, such that the detectors are protected from being saturated with the input light. Light sources and detectors may be designed to operate at a particular wavelength or may be broadband. The frames often include bezels that hide the light sources from the user.

In one type of touch screen panel described in the U.S. Pat. No. 5,914,709 issued on Jun. 22, 1999 and U.S. Pat. No. 6,351,260 on Feb. 6, 2002, both to Graham et al, disclose position information of a touch event using a light grid located in a touch panel. A transmitter placed at one corner of the touch panel generates a light grid using one or more waveguides placed along two adjacent edges of a rectangular frame of the touch panel so as to illuminate the frame from x and y directions, respectively. The transmitter may comprise optical sources such as Light Emitting Diode (LED), or an edge emitting laser or a small light source of other kind

A second set of waveguides positioned to face a respective light grid waveguide directs light traversing in the light grid to a corresponding sensor for example, a camera, photo-detector, detector array, located at another end of second set of waveguides. A touch event using a finger or a stylus placed on the touch panel changes the light transmission by changing the guiding properties of the waveguide at that point thereby, blocking or scattering the light. A loss of light condition is registered at one or more detectors in x and y directions. The physical positions of those sensors generate an electrical signal to determine x and y coordinates of position of the touch event by processing the electrical signal.

In a slightly different approach described in the U.S. Pat. No. 6,181,842 issued on Jan. 3, 2001 to Francis et al., an integrated waveguide system located in a touch panel illuminates a free space area above a display panel using a light transmitter including one or more optical sources for example, a LED. The waveguides are placed to generate a uniform illumination over a display screen. A corresponding waveguide system positioned across from the illumination waveguides direct the received light to a set of sensors or detectors. A touch event interrupts a steady stream of light received at one or more detectors. The positions of the detectors that experience loss of light determine the coordinates of the touch event on the display screen. The waveguides in the above mentioned touch screen panel may include optical waveguides or fibers.

In a similar touch screen panel disclosed in the U.S. Pat. No. 7,352,940 issued on Apr. 1, 2008 to Charters et al., a light grid is generated by coupling light from a light source such as a LED, an edge emitting diode laser or a Vertical Cavity Surface Emitting Laser (VCSEL) to a waveguide array using reflective optics. The waveguide array may also be designed to distribute light uniformly in a lamina (a thin sheet of light) instead of generating an array of discrete sources. In an improved version of a similar device disclosed in the U.S. Pat. No. 7,421,167 issued on Sep. 2, 2008, to Charters et al., an optical splitter is used for distributing light from a multi-mode waveguide to an array of waveguides through a slab region for even distribution of light in the lamina. However, only a limited number of waveguides may be accommodated in a frame under a bezel of the touch screen panel thereby, posing a practical limitation on the uniformity of light distribution in the lamina particularly so, for a large display screen.

In an alternative approach disclosed in the United States Application Publication No. 2013/0135258 by King et al. on May 30, 2013, a planar transparent sheet is disposed over a display screen. Light sources and detectors are placed at the perimeter of the transparent sheet. More specifically, the detectors are placed at one or more corners of the transparent sheet such that light is detected over lines-of-sight between the light sources and detectors. Attenuated lines-of-sights and in particular central lines on the attenuated lines-of-sights are established to determine the location of the touch event using an intersection of the central lines-of-sight and in particular by the average of all such intersection locations obtained from different detectors. In this particular design, the light source comprises a plurality of LEDs mounted on a flex board along the perimeter of the transparent sheet. The flex board is mounted on a PCB that may also include the bus, the processor and other control electronics. One disadvantage of such an arrangement is that there is a physical limitation on the minimum distance between each discrete LED. Therefore, if the touch event is initiated by a small stylus, the position determination may have some uncertainty.

In an alternative type of touch screen disclosed in the U.S. Pat. No. 7,538,759 issued on May 26, 2009 to Newton, the touch panel comprises a front and a back panel supported on frames on all sides. The frame edges include light source placed at one edge of the touch panel to transmit light in an interior volume of the touch panel by total internal reflection (TIR). The light is received by one or more receivers such as a photo-detector located on the opposite edge from the light sources. Alternatively, video camera may be placed behind the back panel. A touch event on the touch panel disrupts the TIR in the interior volume thereby light to scatter or leak out of the touch panel. The scattered light may be detected by detectors or by the video camera for processing.

One variation of this type of touch panel may comprise a planar thin sheet of transparent plastic or glass that acts as a lightguide. Light is coupled in the lightguide from an edge or a surface. The lightguide supports transmission by TIR and a user initiated touch event disrupts the TIR condition or frustrates the TIR condition (Frustrated Total Internal Reflection or FTIR). In a non-patent literature publication entitled “Low-Cost Multi-Touch Sensing through Frustrated Total Internal Reflection”, published by Jefferson Y. Han in a conference proceeding UIST'05, Oct. 23-27, 2005, Seattle, Wash., USA, the FTIR effect is utilized in configuring a multi-touch touch sensor.

In this invention a touch screen system is provided with a radiation source comprising a plurality of monolithic surface mountable VCSELs grown on a common substrate. The VCSELs may be arranged in one or two dimensional arrays that form a VCSEL array chip. The surface mountable VCSEL array chips according to this invention may be configured to emit collectively using a single driver, or configured as clusters of VCSELs driven together, one or more sub-arrays of few VCSELs, each sub-array driven one at a time or a group of sub-arrays driven collectively. Current drivers may be integrated with other electronic circuits for providing logic and control processing capability on a common platform, such as a printed circuit board. Furthermore, VCSEL may be monolithically integrated with photo-detectors for more compact touch screens.

In addition, simple optical components such as lenses placed externally or micro-lenses integrated monolithically with the VCSEL arrays, are provided for beam shaping because radiation emission from VCSEL is symmetric and is distributed in a cone with low divergence. Furthermore, emission from VCSEL is relatively insensitive to temperature and does not require temperature control for wavelength stabilization. One aspect of this invention is to provide extended cavity and external cavity VCSEL array sources for improved wavelength stabilized and polarization insensitive radiation source.

### SUMMARY OF THE INVENTION

In this invention a touch screen system is provided for display screens either as an overlay or integral to the display screen. The touch screen system comprises a transparent planar lightguide having a front (top) and rear (bottom) surfaces and four edges. In one embodiment a touch screen system is disposed over the display screen such that the display screen is visible through the planar lightguide. The touch screen system includes a plurality of monolithic VCSELs for illuminating the lightguide. Radiation is coupled through one or more edges or one or more corners of the lightguide. Radiation is confined within the lightguide by total internal reflection (TIR).

In one embodiment of the invention a location of a touch event on the lightguide is determined by imaging a portion of the radiation scattered out of the lightguide due to Frustrated Total Internal Reflection (FTIR) at the location of the touch event. The scattered radiation is detected using a sensor such as a photo-detector or an array of photo-detectors including a charge coupled device (CCD), or a camera. In a variant embodiment a video camera is used as a sensor for detection of the scattered radiation. The sensor may be positioned above or below the lightguide.

In another embodiment, a transparent sheet of radiation is provided over a display screen. A thin radiation sheet is projected directly over the display screen such that the display screen is visible through the radiation sheet. In one aspect of the invention the thin sheet of radiation provided over the display screen is continuously monitored. When an object such as a finger or a stylus interacts with the radiation sheet, detectors located at the opposite end, detect a loss of radiation. An electrical signal generated in response to the loss of radiation is processed to determine the location of the object using software.

In a variant embodiment, the touch screen is integrated with the display screen or the touch screen is a component of the display screen. For example, a glass or sapphire substrate comprising the display screen may be configured to function as a lightguide. The touch screen is implemented by providing radiation sources and detectors along the edges of the display screen. The location of the object may be determined by imaging loss of light at one or more detectors or by imaging radiation scattered by an object such as, a finger or a stylus used for the touch event.

In yet another variant embodiment, the touch screen may include a rigid planar lightguide with a second flexible lightguide positioned above the first lightguide but not in physical contact with it. The scattered light may be detected from the first, second or both lightguides for improved accuracy.

In one aspect of the invention, radiation from the radiation source may be coupled to the lightguide directly from a VCSEL array source or indirectly by using passive components such as optical fiber, waveguide array, or reflective optics such as micro mirror assembly.

In a different aspect of the invention radiation beams are reshaped using optical component for more uniform and intense illumination of the lightguide or free-space projection of a radiation over the display screen. One advantage of the radiation source comprising VCSEL arrays is that simple optical components may be adequately used for beam shaping. In another aspect of the invention, some optical components such as a microlens array may be integrated with the VCSEL array.

### BRIEF DESCRIPTION OF THE DRAWINGS

Different aspects of the invention are described using several embodiments that represent best practice modes of the invention. These aspects are shown in accompanying drawing figures that form a part of the specification. For clarity, each drawing figure depicts only few important features at a time. However, different combinations and sub-combinations may be made by combining different features shown in different drawing figures in which:

FIG. 1 is a schematic representation of a basic touch screen that may be configured using a VCSEL array source;

FIG. 2 is a schematic representation of a monolithic VCSEL array configured with (a) two mirrors and/or an integrated third mirror, and (b) an external third mirror;

FIG. 3 shows a schematic view of a VCSEL array integrated with a self-aligned array of microlenses (prior art);

FIG. 4 shows a schematic drawing of a VCSEL or a VCSEL array with the output transmitting through a cylindrical diverging lens to create an illuminating beam spread in the lateral direction;

FIG. 5 shows the use of a diverging lens in combination with a microlens array provided to form a highly collimated uniform thin beam in a lateral direction from a VCSEL array;

FIG. 6 shows a schematic view of an integrated VCSEL-photodetector combination as a building block for an array of sources and detectors; the inset shows an integrated extended cavity three mirror VCSEL;

FIG. 7 is a schematic representation of using a VCSEL array source for illuminating a lightguide touch screen from an edge;

FIG. 8 schematically shows coupling a plurality of collimated light beams from a VCSEL array at an edge of a lightguide touch screen;

FIG. 9 schematically shows a lightguide illuminated at two opposite edges using an integrated VCSEL-detector array; the detectors receive light from respective opposite edges;

FIG. 10 shows a representation of a touch screen with an array of VCSELs coupled into a first lightguide and a second flexible lightguide is positioned over the first lightguide;

FIG. 11 is a schematic representation of a touch screen illuminated with a thin light sheet projected over the display screen using (a) a divergent beam positioned at one corner of the touch screen, and (b) a plurality of collimated beams positioned at one edge;

FIG. 12 is a schematic showing coupling VCSEL output beam into an optical fiber; (a) direct coupling, (b) lens coupling, and (c) taper component coupling;

FIG. 13 is a schematic representation of a divergent VCSEL beam coupled to a touch screen lightguide using optical fiber;

FIG. 14 schematically showing (a) different coupling schemes to illuminate a fiber bundle using a VCSEL array source, and (b) a lightguide illuminated by a fiber bundle connected to a VCSEL array source;

FIG. 15 is a schematic representation of coupling a VCSEL array to a waveguide array for providing a plurality of collimated beams for touch screen (a) lightguide type, and (b) free space light projection type; and

FIG. 16 is a schematic representation of coupling a VCSEL array using a plurality of micro mirrors for providing collimated beams for touch screen (a) lightguide type, and (b) free space light projection type.

### DETAILED DESCRIPTION

For clarity and ease of description, each drawing figure shows a particular aspect or a combination of few aspects that may be implemented in an embodiment either alone or, in combination with one or more aspects shown in another embodiment(s). Different aspects presented separately in the form of preferred embodiments are intended to provide a broader perspective of the invention. An element not shown in any particular embodiment is not be construed as precluded from that embodiment unless stated otherwise. Different embodiments by applying combinations and sub-combinations of various aspects of the detailed description of the invention presented in the following sections of the written description that may occur to those skilled in the art, are covered within the broader framework of the invention.

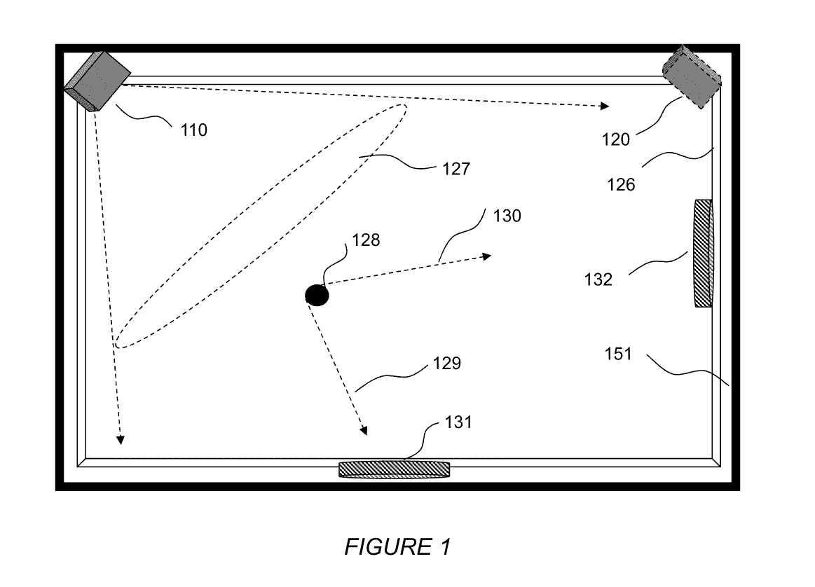

An example of a basic touch screen system (touch screen for brevity) configuration where the invention may be applied is shown in FIG. 1. In general, a touch screen may be applied as a separate add-on touch panel to a display screen of an electronic device such as a computer screen or a screen of a tablet, smartphone, PDA, etc. or a touch panel may be integral to the display device. The description provided in the specification applies to both types of touch screen. In either form, the touch panel is sealed with the display device in most application to protect the touch panel from physical damage or environmental degradation.

In the embodiment shown in FIG. 1, the touch screen is located in front of a display screen 151 of a device for example, a computer, a tablet, a PDA, a smartphone etc. which requires user input for selecting a function or feature of the device. The invention may be used in different device operation including but not limited to, data input, drawing, selecting, moving, forwarding/sharing etc., often performed in the above mentioned devices. In a simple form, the touch screen comprises a clear transparent touch panel 126 disposed over the display screen so that a user can see through the touch screen and select a displayed object or feature by touching the transparent panel at the desired location.

In this particular example, the touch panel includes a planar thin sheet or a laminate of a clear transparent material preferably a scratch resistant material such as, a clear plastic laminate comprising acrylic, polycarbonate, a thin clear glass sheet comprising an ordinary glass or a special glass or sapphire. While a rectangular touch panel is shown in this example, the touch panel can be configured in any other shape. The thickness of the touch panel may be such that the touch panel is rigid or flexible to the touch. Alternatively, the touch panel may comprise a rigid material with an overlay of a flexible material. The touch panel has a front and a back surface and at least four edges. An additional transparent coating of a scratch resistant material may optionally be disposed on at least the top surface to protect the touch panel. The material mentioned here are just examples and other material that have these desired properties may also be used instead.

In most common form, the back surface of the touch panel is disposed in close proximity of the display screen such that the edges of the touch panel are substantially aligned with the edges of the display screen. The touch panel may be in physical contact with the display screen but, it is not necessary to be so. The edges may be polished smooth for effective coupling of light into the volume of the touch panel. It is noted that the ‘light’ in the following discussion is used synonymously with electromagnetic radiation and is not limited only to visible light. Light from a source for example, a VCSEL source 110 is coupled into the volume of the touch panel. The light may be coupled from the edge of the touch panel or may be surface coupled at one corner or preferably at two corners by adding another source 125, or along one or two adjacent edges of the touch panel, for better uniformity. In another form the display screen may be the touch panel as well.

It should be noted that the refractive index of the touch panel material is higher than the refractive index of air surrounding the touch panel. Therefore, the touch panel essentially functions as a thin planar lightguide (to be referred as lightguide hereinafter). The light 127 coupled in the lightguide is confined in the planar volume of the lightguide by total internal reflection (TIR) as long as the refractive index difference is maintained to support the TIR condition. Alternatively, the glass or sapphire substrate of the display screen may be configured as a lightguide where by placing light emitters at the edges or corners, to illuminate the display screen.

When an object, such as a finger or a probe for example, a pen or a stylus 128 comes in contact with the lightguide externally (a touch event hereinafter), the refractive index at the point of contact changes, thereby locally disturbing the TIR condition. The light is no longer confined completely in the lightguide in the vicinity of the touch event and a portion of the light originally confined in the lightguide is coupled and scattered out of the plane of the lightguide at the point of contact shown by arrows 129 and 130. The effect is referred as Frustrated Total Internal Reflection (FTIR) in the art.

Cameras or other suitable sensors or detectors 131 and 132 including but not limited to, photo-detector to match the wavelength of the source light, a charge coupled device array (CCD), a video camera, etc. are placed to record the scattered light at one edge or preferably at two adjacent edges of the lightguide above the surface of the lightguide. It is noted that the light may be scattered out of both surfaces of the touch panel. In the embodiment where the display screen is configured as the lightguide, the sensors are positioned at the edges of the display screen opposite to the light sources.

The touch screen further includes electronic circuits such as, current drivers, processors, controllers, and other circuit elements (not shown) that provide connectivity between the sources, detectors, cameras, processors and controllers (not shown in the drawing figure). The scattered light detected at the cameras or the detectors are converted to electrical signals that are processed and analyzed in software, to determine the lateral location of the object on the lightguide. The software may be specific to the touch screen device or other standard data analysis software may be applied with equal effect.

One important aspect of the arrangement shown in FIG. 1 is to detect the scattered light by placing two detectors on two adjacent edges of the touch panel. This arrangement allows detection of scattered light with better accuracy by determining the location of the touch event on the touch panel by a method of ‘Triangulation’. The method is well known in the art and has been described in several publications including the U.S. Pat. No. 5,317140 issued on May 31, 1994 to Dunthron, and will not be described further. It is also noted that although the principles are described using a light source, the invention may be adapted to work with any other source of electromagnetic radiation at any wavelength for example, visible, infrared wavelengths, or other known light sources.

Typically, the light detectors are positioned relative to the source such that the radiation from the sources does not saturate the detector or put a glare on the top surface of the touch panel. Often, the sources and detectors are covered with a bezel to hide them from the user. The bezel may be in the form of a plastic cover or a thin film coating that allows light of certain wavelength to pass and absorbs non-essential radiation. These and other methods of selective transmission of radiation are well known in the art and will not be discussed further.

### VCSEL Array Sources:

The touch screen may be constructed using different types of illumination sources. However, the most common source currently used are semiconductor light sources such as high power LEDs and edge emitting laser diodes or a linear array including a plurality of them as described in the United States Application Publication No. 2013/0135258 by King et al. on May 30, 2013. Those skilled in the art will recognize that there is a physical limitation on the packing density in assembling an array of individual devices on an external platform such as a flex board, a PCB or on another substrate of choice. Therefore this type of array source may be used with limited resolution.

In a different prior art touch screen, individual VCSEL devices are used due to superior spectral properties. In particular in the U.S. Pat. No. 7,352,940 issued on Apr. 1, 2008 to Charters et al, it is disclosed that VCSEL may be used in a touch screen to distribute light in a plurality of waveguides to generate a light grid. However, the number of waveguides in a grid that may be connected to a single VCSEL is rather limited. It can be easily appreciated that the resolution will be limited unless multiple sources are used.

One important aspect of the touch screen constructed according to this invention is to use a light source comprising a plurality of VCSELs or preferably, arrays of VCSELs constructed monolithically on a common substrate. One advantage of a monolithically integrated VCSEL array source according to this invention is that all the VCSEL devices in the array may be configured to be operated individually, in small groups or clusters, sub-arrays comprising separate rows (or columns) of an array, or the entire array may be operated using a single current driver to emit light collectively. Another important aspect of the monolithic integration is that the adjacent VCSELs in the array may be positioned very closely thereby achieving a high packing density (or alternatively, a small array pitch) and consequently, high optical output power and uniform distribution of optical power in a small foot print may be achieved.

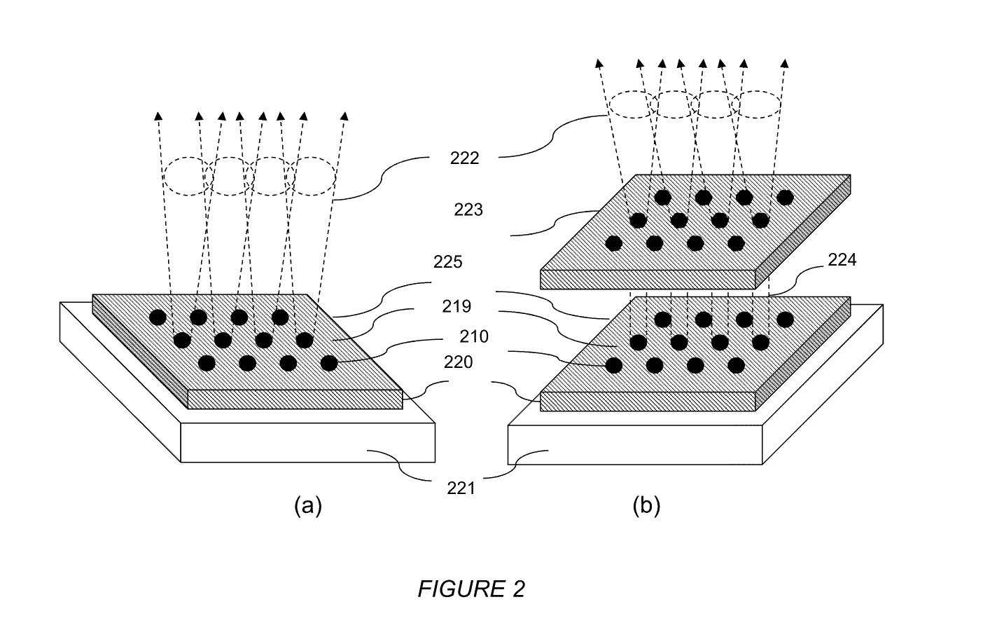

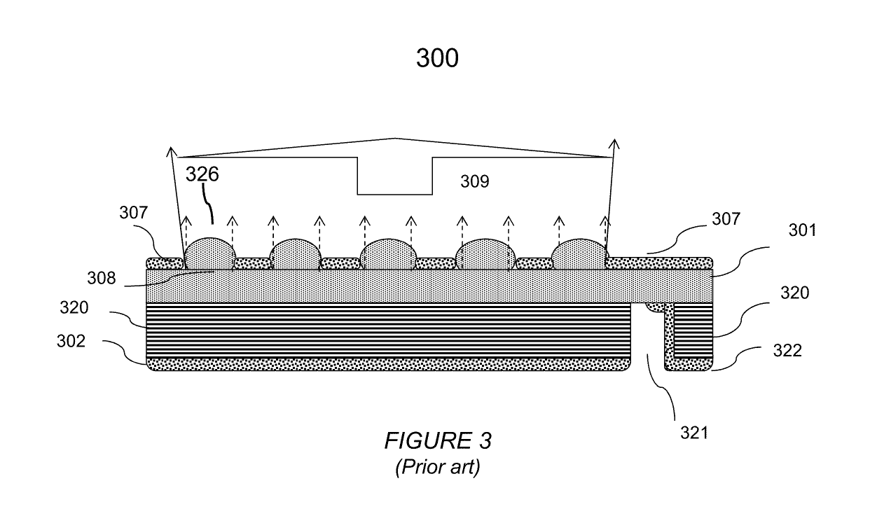

There are several variants of the VCSELs that may be used for the touch screen optical source according to this invention. The most commonly known VCSEL in the art is a self-emitting two mirror VCSEL. One important aspect of this invention is that the VCSELs used for touch screen is configured in a surface mountable form that is described in a co-pending and co-owned U.S. patent application Ser. No. 13/783,172 filed on Mar. 1, 2013, by Seurin et al. In particular, in the U.S. patent application Ser. No. 13/783172, the schematic of a conventional two reflector (also referred as mirror) top and bottom emitting VCSELs are shown in FIGS. 2a and 3a, respectively, and described in paragraphs [0041] -[0052] in said co-pending application. The drawing figures and associated description from said co-pending application is being incorporated by reference in its entirety. For the purpose of a light source for a touch panel, both top and bottom emitting device would work equally well.

However, a preferred option for a touch panel light source for better wavelength and polarization stabilized operation is an extended cavity VCSEL including an integrated third mirror or with an external third mirror. Examples of extended cavity VCSEL devices are shown in FIGS. 2b, 2c, 3b and 3c and in FIGS. 2d and 3d, in top or bottom emitting mode, respectively, in said co-pending and co-owned U.S. patent application Ser. No. 13/783172. The schematic drawing figures of extended and external cavity VCSELs as shown in FIGS. 2 and 3 and described in paragraphs [0041]-[0052] in said co-pending application is being incorporated by reference in its entirety. In the extended and external cavity VCSEL a third mirror is designed to have a pre-determined reflectivity and is placed at a pre-determined distance above the second mirror such that the combined phase matched reflectivity of the second and third mirrors provides sufficient feedback to sustain lasing in the cavity.

While a single conventional or extended cavity VCSEL may provide adequate illumination for a small size touch panel, for higher optical power adequate for uniformly illuminating a larger size touch panel, arrays of VCSELs are preferred. Advantageously, VCSELs are surface emitting devices and therefore are easy to integrate monolithically on a single substrate as shown in FIG. 2. Any type of VCSEL devices namely, self-emitting (two mirrors) or extended cavity with an integrated third mirror, may be used to construct a monolithic VCSEL array shown in FIG. 2a. In particular, VCSEL devices configured for surface mounting are a more preferred choice. Extended cavity VCSEL array with an external third mirror is shown in FIG. 2b. In FIGS. 2a and 2b, parts that are substantially identical or perform identical functions are labeled with the same reference numerals.

More specifically in FIGS. 2a and 2b, a VCSEL array device 219 shown therein, comprises a two-dimensional array of a plurality of VCSEL devices 210 (only one dot representing a VCSEL device is labeled for clarity). All the VCSELs are constructed on a common substrate 220. All the VCSEL devices in the array are electrically connected to the substrate which functions as a first common terminal of the array. In order for the VCSELs to emit collectively, the second electrical contact of each VCSEL in the array is connected using a common metallization on the array surface which functions as a second common terminal of the array. While this particular configuration has certain advantage, it should not be construed as the only possibility.

It is noted that the VCSEL array so constructed has an option to place the common first and second common terminals of the VCSEL array to be accessible on the same side of the array, preferably on the surface on the non-emission side of the array in a surface mountable form. A more detailed description of a monolithic VCSEL array is provided in a co-pending and co-owned U.S. patent application Ser. No. 13/541,906 filed on Jul. 5, 2012, by Seurin et al., the content of said application is being incorporated by reference in its entirety. Those skilled in the art will readily recognize that the VCSEL array disclosed herein is readily adaptable for surface mounting. And while there are other ways to make the arrays surface mountable, the ones described in the co-pending and co-owned U.S. patent applications Ser. No. 13/541,906 filed on Jul. 5, 2012, and Ser. No. 13/783,172 filed on Mar. 1, 2013, both by Seurin et al. are the preferred for this purpose.

For the ease of description, the VCSEL array as shown in FIG. 2 will be referred as VCSEL array chip (or array chip hereinafter) where all the VCSEL devices are connected to emit collectively in an upward direction shown by the circles 222. The array chip 225 is shown mounted on an optional thermal submount 221 which is particularly important for thermal management of a large size array chips. Any type of thermal submount described in a co-pending and co-owned U.S. patent application Ser. No. 13,337,098 filed on Dec. 24, 201, by Seurin et al., content of which is being incorporated by reference in its entirety, will be equally effective depending upon the heat dissipation requirement.

The extended cavity VCSEL array chip shown in FIG. 2b is substantially similar to the array chip shown in FIG. 2a except for the external third mirror 223 being placed above the emission surface of the array chip. The third mirror is located at the design specific pre-determined distance from the surface of the VCSEL array 219 so that the combined cavity of the three mirrors sustains laser action 224 in each VCSEL device with the desired characteristics. The output beams 222 from the array of VCSELs are transmitted out of the mirror 223. It is noted that the description provided to construct a VCSEL array is equally applicable for top emitting or a bottom emitting VCSELs.

While the array chip shown in this example has VCSELs arranged in a square, an array chip may be configured in any regular geometric pattern for example a linear array, a circular array or in any other random shape which is particularly advantageous for a touch screen that is not of a regular geometric shape. Furthermore, VCSELs in an array may be configured to operate collectively, as individual devices, in small groups/clusters or sub-arrays to be operated together. For example, a cluster may comprise all the VCSELs in a particular row or column of the array or it may be a group of VCSELs lighting a particular portion of the lightguide, such that a group/cluster may be connected together to emit together. This particular aspect is extremely suited for addressing the clusters or sub-arrays using a timed drive current for synchronous operation and detection. These and other variations of combining VCSELs in groups may be apparent to those skilled in the art.

### Beam Shaping for Collimating and Divergent Illumination Source:

As mentioned earlier, light emission from VCSEL is very symmetrical about the emission window because the emission pattern is determined by the current confinement ring, which is generally in the form of a circle. It is the same design aspect which makes the emission less divergent as well. Therefore VCSEL array emission comprising equal intensity beams from each element of the array merged at a short distance is quite uniform. At distances farther and farther away, the divergence is more noticeable. To achieve a uniform illumination over a larger area, additional optical components may be used for beam shaping.

Due to symmetric nature of the emission, simple optical components such as a single lens may be adequate to collimate emission from the entire array. However, that approach requires that the distance between the adjacent VCSELs in the array is set appropriately, such that emission from each VCSEL overlaps to make the collective collimated emission from the entire array uniform. While this method may be satisfactory, it does not have much flexibility. In a preferred arrangement an array of microlenses is provided to collimate emission from individual VCSEL of the array.

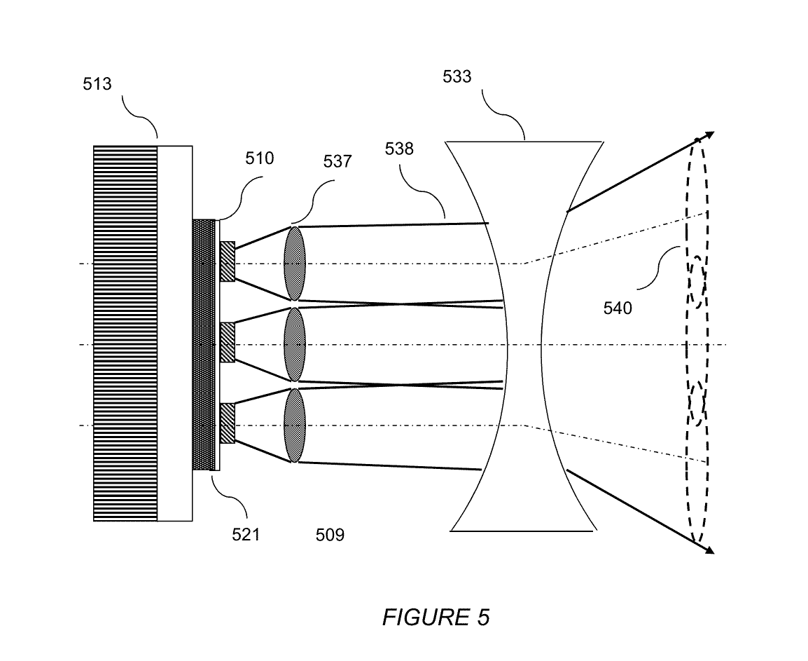

One such arrangement is shown in a co-pending and co-owned U.S. patent application Ser. No. 13/783,172 filed on Mar. 1, 2013, by Seurin et al which is being incorporated by reference. More specifically, FIG. 5 of said co-owned application discloses a beam shaping arrangement using a microlens array positioned in front of a VCSEL array. A detailed description of that arrangement is provided in paragraph [0059] of said co-owned application. In particular, the drawing figure shown in FIG. 5 and the associated description in paragraph [0059] are being incorporated by reference in its entirety.

In an alternative embodiment, a microlens array is provided integrated with the VCSEL array. More specifically, in this particular example an array of bottom emitting VCSELs 300 is shown. The VCSEL device structure collectively shown as 320 (the active layer and the mirrors, etc. are not shown in details) is grown on a substrate 301. The VCSEL array includes a common first electrical contact 307 as a contiguous metallized layer with windows 308 (only one labeled for clarity) opened in the metallized layer 307 that are substantially aligned with the VCSEL emission windows. A second metallized layer 302 provides a second common electrical contact to the VCSEL array. Furthermore, the VCSEL array shown in this example is configured to be adaptable for surface mounting. More detail of individual device structure is provided in the co-pending and co-owned U.S. patent application Ser. No. 13/541,906 filed on Jul. 5, 2012, by Seurin et al. That description in said co-owned patent application is being incorporated by reference in its entirety.

In this embodiment, each VCSEL in the array (shown as window 308) is provided with a self-aligned microlens 326 (only one labeled for clarity), thereby integrating a microlens array with the VCSEL array. The microlens array is constructed by reprocessing the substrate 301 to integrate the microlens array with the VCSEL array. Emission from each window is collimated. The separation between adjacent VCSEL devices (and therefore the microlenses) is pre-determined such that the collective emission shown by the big arrow 309 is made to be fairly uniform at a desired distance above the array. It is further noted that while the principles are described in reference with a bottom emitting VCSEL array, it can be modified suitably to incorporate top emitting VCSELs as well. In that scenario, integrated self-aligned microlens array is selectively etched or grown over the VCSEL window by any low temperature etching or growth process, such as a physical or chemical etching or deposition method, that are widely used in the art. One preferred method is described in a co-owned (also co-authored by some of the inventors of this invention) U.S. Pat. No. 6,888,871, issued on May 3, 2005 to Zhang et al.

Those skilled in the art will be able to appreciate that a VCSEL array integrated with a self-aligned microlens array would form a more compact and uniform light source as compared to using an external lens or an external microlens array, and is extremely beneficial as a light source for the touch panel shown in FIG. 1 where a small form factor would be desired. It is further noted that when light is coupled to the touch panel shown in FIG. 1, it is desirable that the illumination beam has a wide beam angle in the lateral dimensions to fully illuminate the area of the lightguide to realize high coupling and scattering intensity for a touch event on the touch panel. Since the lightguide is relatively thin, a direct coupling of light source may not be extremely effective. Therefore it is also important that the illuminating beam has a small divergence angle along the other dimension of the touch panel (z-direction hereinafter for convenience of description). This maintains the beam dimension smaller than the width of the lightguide and also keeps the angle small so that it is smaller than the acceptance angle of the lightguide.

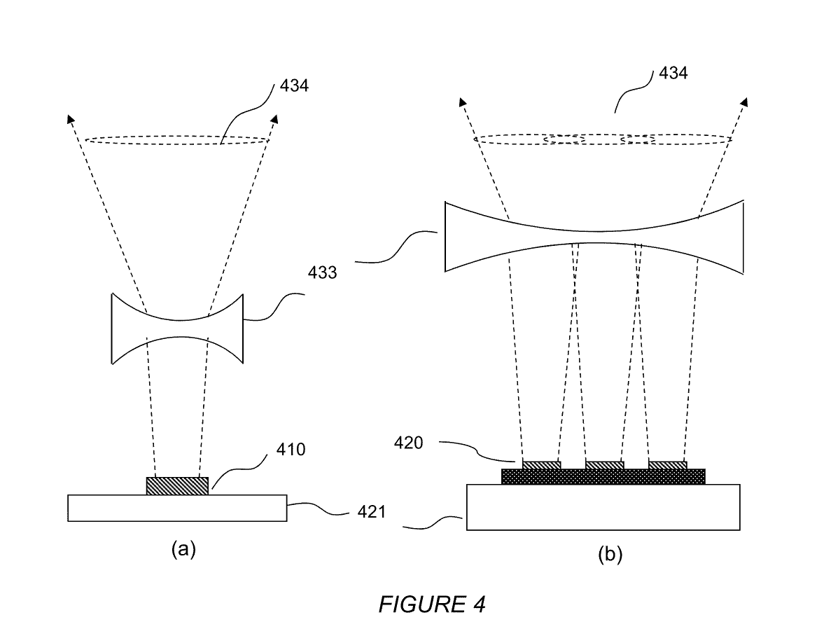

The output beam from the VCSEL inherently has a small divergence angle which in many cases is adequate for coupling into the lightguide. One simple method to increase the lateral angle is by using a cylindrical lens to create the fan-shaped beam profile which is demonstrated in FIG. 4 respectively, for a single VCSEL device (FIG. 4a) and for a VCSEL array (FIG. 4b). More specifically, a cylindrical concave lens 433 is placed in front of the VCSEL device 410 (FIG. 4a) or a VCSEL array 425 (FIG. 4b). The emission profile 434 of the VCSEL (or array), after traversing the lens has divergence increased in one dimension while remaining the same in the other dimension. The beam thus has an oval shape.

For the VCSEL array shown in FIG. 4b, it is important to place the concave lens at a suitable distance from the VCSEL array such that individual emission from each VCSEL has a desirable overlapping between the beams, such that the composite or collective emission has relatively uniform intensity with no low intensity regions between the VCSEL beams. It can be appreciated by those skilled in the art that VCSELs may be configured in a linear or a two dimensional array depending on the dimensions and properties of the lightguide. Furthermore, the light source may optionally be mounted on a submount 421 depending upon the size of the array and other thermal management considerations.

A variant embodiment shown in FIG. 5, is an example of a combination of optical components to generate an output beam that is highly collimated in one dimension yet maintain high divergence in another. In particular, a VCSEL array 525 (only one labeled for clarity) is optionally mounted on a thermal submount 521 is configured with an array of microlens 537 (only one labeled for clarity). This configuration has been described in the co-pending and co-owned U.S. patent application Ser. No. 13/783,172 filed on Mar. 1, 2013, by Seurin et al, with a particular reference of drawing figure shown in FIG. 5 and associated description in paragraph [0059], that description is being incorporated by reference in its entirety.

More specifically, the microlens array is positioned at a pre-determined distance from the VCSEL array, such that the emission 509 from individual VCSELs in the array are collimated and substantially overlap at the edges, so as to provide a composite beam having a continuous and uniform intensity profile (no gap between the emissions from individual VCSELs). A cylindrical concave lens 539 is placed in the beam downstream from the microlens array at an axial distance 538 from the microlens array such that the composite beam 540 out of the concave lens provides increased divergence in one dimension but maintains the highly collimated properties of the beam after the microlens array and before entering the concave lens in the other dimension.

VCSEL Array Source Integrated with Detector:

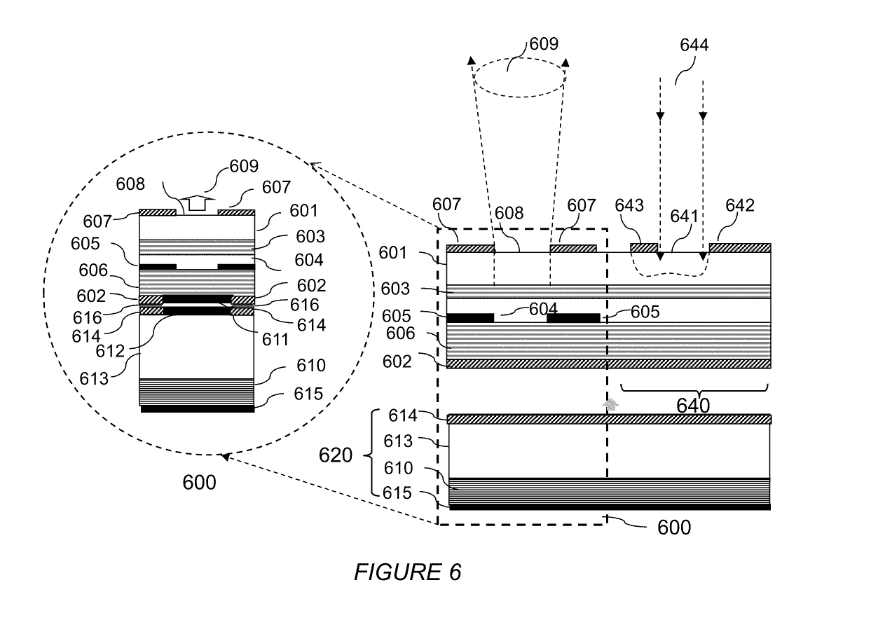

In a variant embodiment, a plurality of detectors (or in general a sensor) for example, photo-detectors may be integrated with the VCSEL array that may be used as a source for touch panel application. Specific example of such an application will be described later in another section. Those skilled in the art will be able to appreciate that VCSEL is a surface emitting device, therefore constructing another surface device such as a photo-detector (referred as a detector hereinafter) monolithically with the VCSEL is rather straightforward. One example of such an integrated source-detector combination is shown in FIG. 6, where a VCSEL is constructed with a detector on the same substrate, preferably using the same quantum well material as the VCSEL, thereby assuring that the integrated VCSEL and photo-detector pair operates at the same wavelength.

More specifically, FIG. 6 on the right shows a module or a unit comprising respectively, a VCSEL (box 600) and detector (640) pair, and the inset on the left shows an expanded version of the VCSEL 600. While this particular example shows a three mirror extended cavity VCSEL device, other types of VCSEL devices described earlier, will work equally well. Although following description is in reference with a single VCSEL-detector pair for the clarity of explaining the basic principle, it is implied that the description is pertinent to a plurality of such VCSEL-detector pairs configured in a one or two dimensional arrays.

In the configuration shown in FIG. 6 the detector section 640 is fabricated along with the VCSEL 600 on a common substrate 601. More specifically, the entire VCSEL structure comprising an active quantum well layer 604, two mirrors 603 and 606, and the current confinement ring 605, is grown on the substrate 601. The detector section 640 is constructed using the same quantum well and the mirror layers except that there is no current confinement ring. Instead, a p-n junction or a p-i-n junction or a metal-semiconductor Schottky barrier type of metal semiconductor diode, or a metal-semiconductor-metal or a two electrode photoconductive detector structure is constructed in that region by introducing appropriate dopants in the radiation detection window 641 and forming appropriate contact electrodes.

Separate contacts 643 and 642, respectively, provide electrical connections for the two terminals of the detector. Radiation 644 impinging on the detector window 641 generates carriers which are collected at the electrical terminals 643 and 642 to generate an electric current. An electronic or a physical barrier region formed by etching away the current conductive region between the two devices may optionally be provided into the substrate to prevent electrical crosstalk between the VCSEL and the detector. In an array of such VCSEL detector pair, the pair can be individually addressable, so that it can identify specifically the reflected light from different parts of screen for touch screen application.

An expanded view of the VCSEL section 600 is shown in the inset on the left.

Selection of a bottom emission VCSEL is by way of example and should not be construed to be limiting. In this particular embodiment of VCSEL device light emission 609 is from a window 608 open in the contiguous metallization layer 607 deposited on the substrate 601. The metallization layer also provides a first electrical contact to the VCSEL. The mirror 606 in this particular example is made partially reflecting to form the middle mirror in a three mirror cavity whereas the reflectivity of the mirror 603 is kept higher. In fact, same configuration may be constructed using a top emission VCSEL device with appropriate reflectivity adjustments to the mirrors 603 and 606. In a region surrounded by the current confinement ring 605 where the optical beam traverses, the mirror 606 is coated with an antireflection layer 611. A selectively applied (or removed) metallization layer 602 around said region provides a second electrical contact to the VCSEL.

A third mirror 610 is constructed on a separate substrate 613 (represented as block 620). One advantage of the present construction is that the process is scalable to construct arrays of VCSEL-detector pairs on a single wafer and the third mirror constructed separately, may be bonded to the entire wafer in a post processing step. The following description illustrates one possible post processing method to bond the third mirror to a VCSEL and applies equally well to a VCSEL-detector pair. An antireflection layer 612 is applied to the substrate 613 on a surface opposite to the third mirror layer. The area of the antireflection layer substantially matches and aligns with the antireflection layer 611 such that the optical beam traverses along a clear path between the mirrors 603 and 610 forming the extended cavity ends.

An additional metallization layer 614 is optionally applied over the substrate 613 distal to the third mirror in the areas outside the region where the optical beam traverses to facilitate metal-to-metal bonding between the VCSEL and the substrate 613 with the third mirror, using a bonding layer 616. It is noted that this is just one preferred way to integrate the third mirror to the rest of the VCSEL-detector pair in this particular example. An optional metallization layer 615 is disposed at the bottom of the third mirror layer so as to facilitate mounting of the integrated device to a heat sink for thermal management, if needed.

It is noted that the thicknesses of the VCSEL (including the substrate 601, active layer 604, the two mirrors 603 and 606, and the substrate 613 are selected such that the third mirror 610 is positioned below the bottom surface of the VCSEL device at a pre-determined distance. As a result the combined phase matched reflection of mirrors 606 and 610 in the resonant cavity is sufficiently high for sustaining laser action with the mirror 603. Although the third mirror under the detector is redundant, it does not affect the performance of the detector.

While the embodiment is described with a single VCSEL-detector pair for clarity, it can be appreciated by those skilled in the art that the process is adaptable to construct arrays including plurality of VCSEL-detector pairs or even to VCSEL arrays. Advantageously, the method is also well suited for a manufacturing environment because several VCSEL array modules or VCSEL-detector modules may be constructed monolithically on a single wafer in a single processing round, and the third mirror 620 constructed on a separate substrate may be bonded to the entire wafer as shown in FIG. 6 (right hand schematic) using simple post processing steps. Individual modules comprising appropriate size array may then be separated by dicing.

Touch Screen Systems with VCSEL Illumination Source:

Referring back to FIG. 1, there is shows a schematic of a basic touch screen to illustrate the principles. The general description provided in reference with the embodiment shown in FIG. 1 is equally applicable for other touch screen embodiments to be described shortly. VCSEL arrays and/or the VCSEL-detector arrays described in the previous section are very well suited as optical source and in particular, for directly coupling an optical source to a touch screen system (or touch screen in short). While touch screens and in particular, rectangular touch screens typically used with most common display device screens may be designed with other types of sources, VCSEL array sources are particularly advantageous for touch screens having other regular and irregular shapes as well. However, for simplicity, a rectangular touch screen is selected to demonstrate the principles.

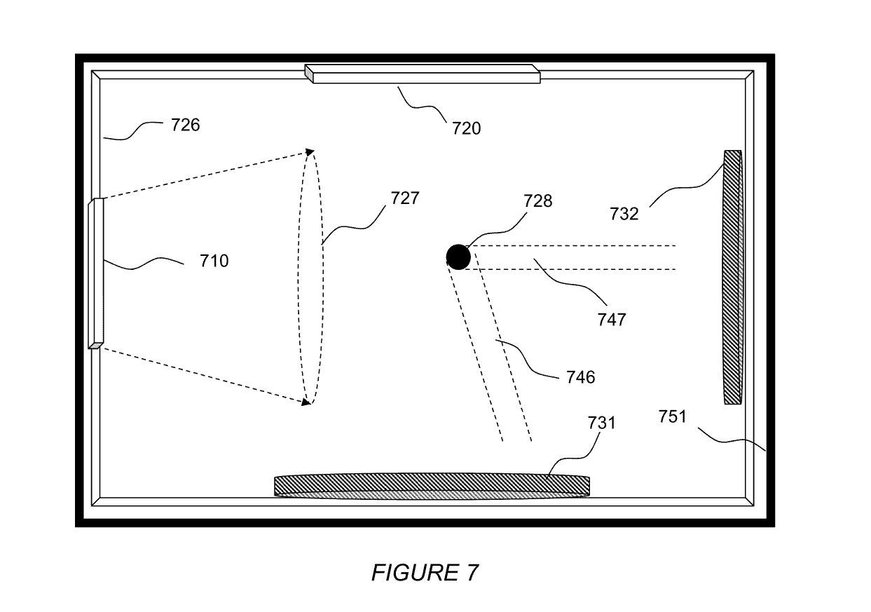

Referring now to FIG. 7, there it shows another embodiment of a touch screen similar to the one shown in FIG. 1. The general description of the touch screen shown in FIG. 1 applies in this case as well. The touch screen in this embodiment includes a touch panel 726 or a planar lightguide, comprising a thin clear and transparent sheet having a front and a back surface. The lightguide is disposed with the back surface proximal to a display screen 751 of a device for example, a display screen of a computer, tablet, a smartphone, etc. It is noted that the lightguide may be integral to the display screen as has been disclosed earlier. The display screen is visible through the transparent lightguide for a user to operate the device using a touch of a finger, a pen or stylus, as the case may be. The lightguide in this embodiment is illuminated from an edge, or preferably two adjacent edges using optical sources 710, and 725, respectively.

The optical sources comprising a VCSEL device or preferably an array of VCSELs are positioned along the edges, such that the light is edge coupled to the lightguide and propagates inside to respective opposite edges. Due to the refractive index difference between the lightguide material and the air surrounding the lightguide, light is guided in the internal volume of the lightguide by TIR. An object, such as a finger or a probe 728 upon touching the surface of the lightguide, increases the refractive index outside the lightguide at the location of contact. The condition of light guiding is temporarily disturbed, such that a portion of light previously confined in the lightguide is coupled and scattered out of the lightguide at the contact location.

As a consequence, the intensity of light guided in the lightguide is attenuated at the location of the contact, thereby forming a low intensity region or a shadow shown as 746, 747 in the touch panel. A sensor such as, a camera or detector array 731 is placed above the lightguide at respective opposite edges from the light sources 710 to detect the location of contact by measuring the light intensity or a signal generated in response to the scattered light detected by the detector. The information from the detector is transmitted to a processor which computes the location of the object 728. A control system is provided to perform the desired operations once the location is determined. In general, a second detector array 732 is additionally deployed for better accuracy. One advantage would be the ability to detect simultaneous multiple point touches to the screen. For simultaneous multiple touch detection, the number of detectors may be increased as well as their location should be spread out along the length of the edges.

It will be apparent to those skilled in the art that the dimensions of the VCSEL array is selected to match the dimensions of the lightguide, for example, the length, breadth and thickness, such that the entire lightguide is uniformly illuminated. The array may be a linear array or a two dimensional array depending upon the thickness and therefore the edge dimensions of the lightguide for efficient coupling of light from the edges. It can be further appreciated that a monolithic array configured to drive all the VCSELs in the array as disclosed in the previous section, is ideally suited for this purpose to keep the VCSEL array compact. However, other option such as driving the VCSELs and VCSEL detector pairs individually or in groups may not be precluded.

An additional advantage of the VCSEL array source as disclosed in this invention is the ability to pack adjacent VCSELs very closely, thereby providing more uniform illumination. VCSEL emission is also highly collimated and therefore very uniform. In addition, simple optical components may optionally be used to further collimate the VCSEL emission from individual devices. For example, individual microlenses, or a single lens may be used to collimate emission from all the VCSELs, or lenses that would produce further divergence in one direction may be used alone or in combination with the collimating lens(es). Furthermore, optical components may be integrated with the VCSEL array for more compact light sources. Such narrow divergence light beams would be useful for more precise determination of the point of touch by an external object such as a finger or touch pen.

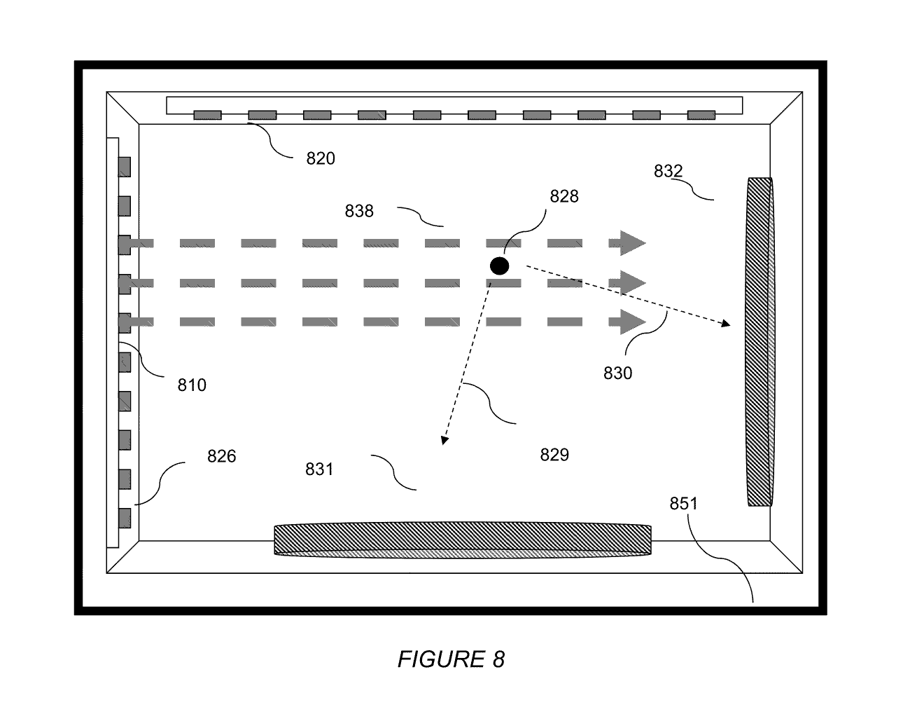

In a different embodiment of a touch screen configuration shown in FIG. 8, an array of collimated beams from a VCSEL array is provided for uniformly illuminating a lightguide. This embodiment is deployed in a similar fashion as the one described in reference with FIG. 7. Same description applies to elements that are substantially similar or perform the same functionality, and are labeled with same reference numerals. In the following description elements that are different from the embodiment shown in FIG. 7 are described in more detail. However, elements that are described earlier and not repeated here should not be construed as precluded from this embodiment.

More specifically, a lightguide 826 deployed over a display screen 851 is illuminated from one edge using a VCSEL array 810. In a more preferred source, a VCSEL array includes additional optical components for example, a microlens array for generating a collimated beam 838 propagating in the touch panel. As has been described earlier, the array pitch (distance between adjacent VCSELs in the array) and the distance of placing the microlenses may be selected such that the individual beams after collimation by respective microlens overlap to provide a uniform illumination in the entire lightguide. If needed, an optional second VCSEL array 825 is employed at an adjacent edge for example, to provide illumination from a different direction. Similar to the embodiment shown in FIG. 7, light in the lightguide is confined due to TIR.

An object, such as a finger or a probe 828, in contact with the lightguide alters the TIR or light guiding condition due to the refractive index change outside the lightguide at the location of the contact. As a result light couples and scatters out of the lightguide at that location shown as dashed arrows 829 and 830, respectively. Intensity of light in the lightguide is attenuated at the location of the touch thereby creating a shadow. A sensor such as, a camera or detector array 831 is placed above the lightguide at respective opposite edges from the light sources 810 to detect the location of contact by measuring the light intensity or a signal generated in response to the scattered light detected by the detector. The information from the detectors is transmitted to a processor which computes the location the contact position of the object 828. In general, a second detector array 832 is additionally deployed to further improve accuracy in determining the position of the finger or probe. A control system is provided to perform the desired operations once the location is determined.

In an alternative embodiment, each camera or detector 831 and 832 shown in FIG. 8 may be replaced by a detector array comprising a plurality of detectors. The detector array is so designed such that the pitch of the detector array matches the pitch of the VCSEL array source. Unlike the camera or detector placed above the lightguide described earlier, the detector array is placed at the edge of the lightguide in a similar fashion as the VCSEL array source. Furthermore, each VCSEL in the source array may be made to align with a detector in the detector array placed on the opposite edge. In the event of a touch by a finger or a probe on the lightguide, loss of light due to light scattering out from the lightguide generates a shadow at the location of the touch. The detectors located in line with the shadow receive less light as compared to light received at the detectors away from the shadow and the signal loss in those specific detectors is processed to determine the location of the touch.

In a variant embodiment, VCSELs may be configured to emit in groups, clusters or in sub-arrays, such that each group, cluster or sub-array is driven separately using a pre-determined pulse sequence such that the lightguide is illuminated sequentially at one edge. The location of the contact of the finger or probe on the touch panel in the processor is determined by synchronized detection of signal in the detector array with the illumination sequence of VCSEL groups, clusters or sub-arrays. In this fashion, the location of the touch event is determined with better accuracy.

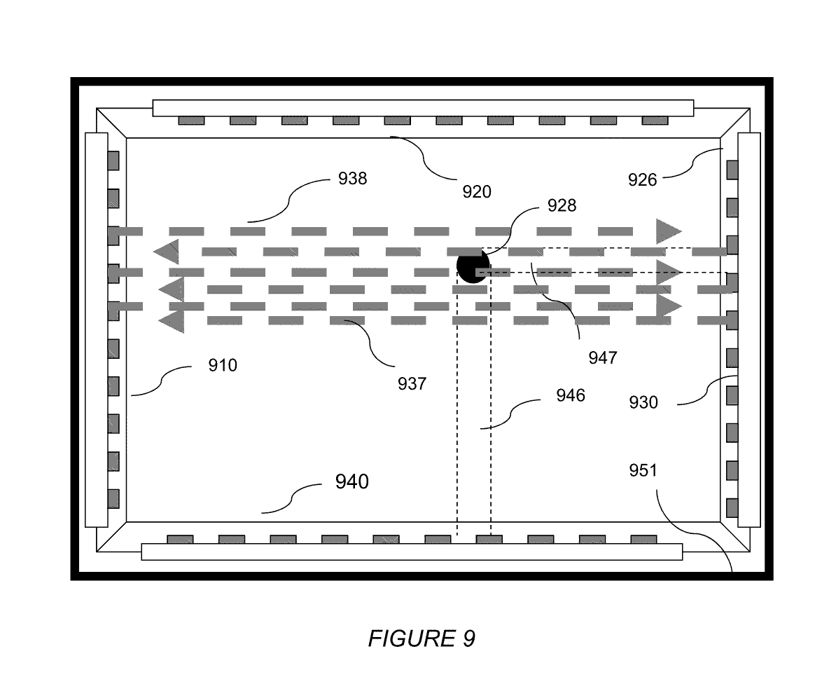

One variation of the embodiment described above, is shown in FIG. 9. This embodiment is configured in a substantially similar manner as the embodiment described in reference with FIG. 8 with a VCSEL array located at one edge for the light source to generate collimating beams and a detector array positioned on the opposite edge. However, in this embodiment separate arrays of VCSELs and detectors are replaced by an array of VCSELs integrated with detectors (VCSEL-detector arrays) described in reference with FIG. 6. More specifically, an array 910 VCSEL source integrated with a detector array is positioned on one edge of a touch panel whereas a substantially similar array 930 of VCSEL source integrated with a detector array is positioned at the opposite edge such that the VCSELs at one edge (in 910) align with the detectors at the opposite edge (in 930) and vice versa.

The VCSELs in the arrays 910 and 930 located at opposite edges provide separate set of collimating beams 938 and 937 traversing in opposite directions. This arrangement provides more uniform distribution of intensity. The shadow 947 produced due to the attenuation of light may now be detected by the detectors in both the arrays 910 and 930. As a consequence, accuracy of locating a finger or probe 928 on the lightguide is substantially improved. Further improvement in accuracy may be achieved by positioning additional VCSEL-detector arrays 920 and 940 on the other two edges. In that configuration, additional shadow 946 may be detected by respective detectors located in the arrays on opposite edges. The synchronized illumination and detection described in the previous section is applicable in this configuration of touch screen as well. Improved accuracy is particularly beneficial for applications including but not limited to simultaneous multiple touch events.

One advantage of improving accuracy by this approach is that the VCSEL-detector arrays may be made more compact without additional optical components. Additional optical components may be used to further improve the collimation of beams from the VCSELs. Those skilled in the art will be able to appreciate that the resolution of detecting a finger touch or a probe is far superior to other prior art methods due to superior emission properties of the VCSEL sources, as well as the ability to integrate such sources (and detectors) monolithically which allows many more sources (and detectors) to be placed within a small physical space.

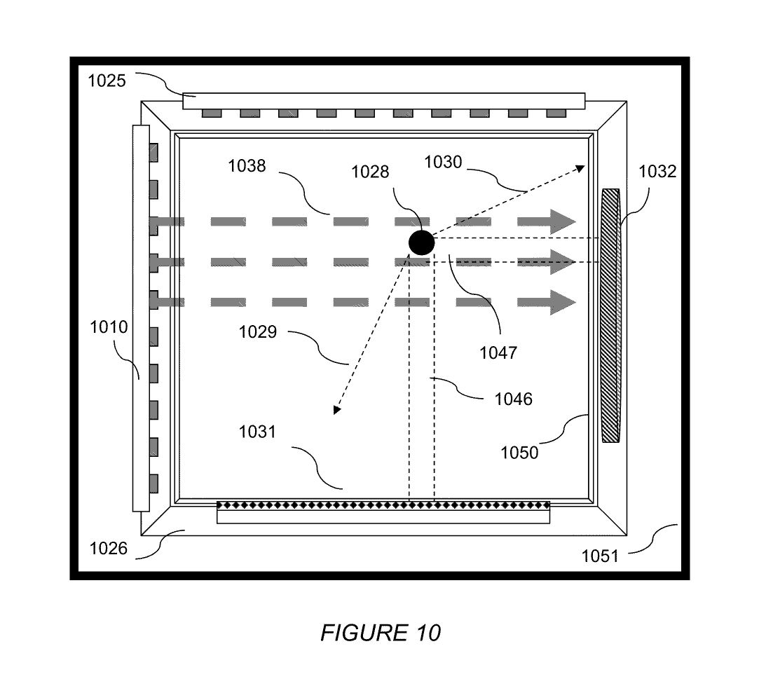

In another embodiment shown in FIG. 10, an alternative mechanism for detecting an object using radiation propagating in a lightguide is described. The basic configuration and working principles of this embodiment is similar to the embodiments described in reference with FIGS. 8 and 9 and will not be repeated for brevity. In this embodiment a light source 1010 or preferably an additional light source 1025 are placed on two adjacent edges of a lightguide 1026 placed on a display screen 1051. The array source provides a collimated beam 1038 which is guided in the lightguide by TIR. In addition, a second flexible lightguide 1050 having a refractive index higher than the medium outside the lightguide is placed near, but not touching the first lightguide 1026.

An object or a probe 1028 touching the second lightguide 1050 locally pushes said second lightguide to make contact with the first lightguide 1026. The contact of the two lightguides at the location of the object disrupts the guided propagation of light in the first lightguide. The light is thus coupled and scattered out of the first lightguide and into the second lightguide shown as 1029 and 1030, respectively. The light coupled to the second lightguide continues to propagate to the edges of the second lightguide. In addition, due to attenuation of light in the first lightguide, shadows 1046 and 1047 generated therein. In this configuration, location of the object may be determined from the first and/or second lightguides which allows more flexibility for example, constructing the first lightguide from a rigid material.

Cameras 1032 or other suitable detectors or array of detectors 1031 are positioned at the edge of the second lightguide to record the scattered radiation 1029 and 1030 and the resulting signal is processed and analyzed using software to determine the lateral location of the object touching the second lightguide. Alternately, position of the object may be determined by the shadows 1346 and 1347, respectively generated in the first lightguide as described earlier in reference with FIGS. 1, 7 and 8.

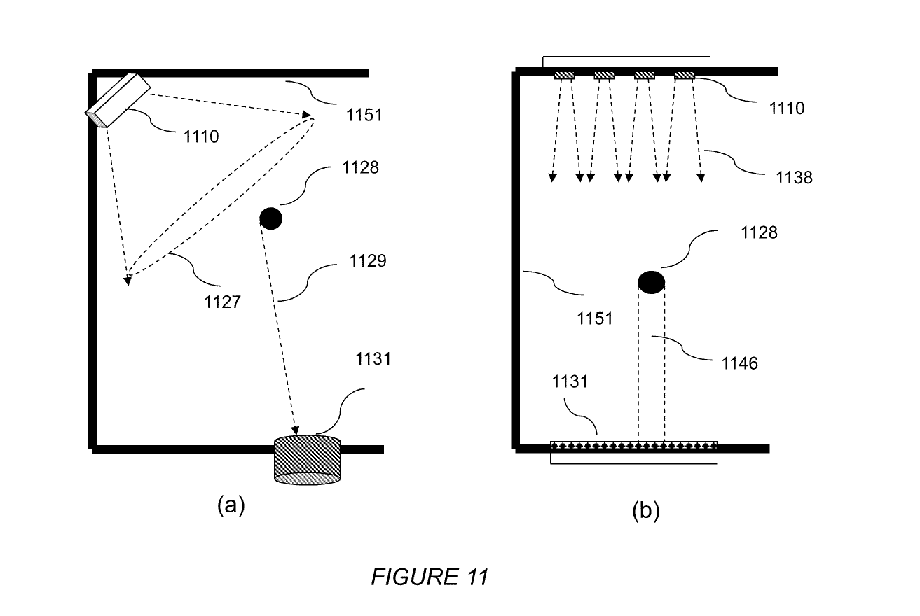

FIG. 11 shows an alternative embodiment of a touch screen technology that does not use a lightguide for illuminating the region in front of a display screen. This method is particularly suited to take advantage from low divergence of VCSEL or VCSEL array emission. More specifically, two different touch screen configurations are shown in FIGS. 11(a) and 11(b), respectively. The embodiment shown in FIG. 11(a) is substantially similar to the embodiment shown in FIG. 1 except, that there is no lightguide. Instead, a highly diverging beam 1127 is directed across the surface of a display screen 1151 from a source 1110 positioned at one corner of the display screen so as to provide illumination over the entire display screen.

The beam is highly collimated in the direction parallel to the surface of the display screen to maintain a thin beam in front of (or above) the display panel. A good analogy for this mode of illumination would be a thin uniform sheet of light being projected in front (or above) a display screen. An object for example, a finger or a probe (pen or stylus) 1128 when placed in the path of the beam results in scattering of the beam at the location of the object. Some portion of the scattered light 1129 is detected using a camera or a suitable detector 1131 positioned at one edge of the display screen, such that the camera or the detector in not in direct path of the illumination beam.

The embodiment shown in FIG. 11(b) is substantially similar to the embodiments shown in FIGS. 7-10 except that there is no lightguide. In this embodiment a collimated beam 1138 from a VCSEL array source 1110 is deployed directly in front of (or above) the display device screen 1151. Cameras, detector or a detector array 1131 is used to detect the shadow 1146 created by the object 1128 in the array of beams. Alternately (not shown) the light scattered from the object may be imaged into cameras or suitable detectors positioned away from the direct beams. Additional optical elements may be used for creating highly collimating overlapping beams from the VCSEL array for better uniformity of illumination and accuracy of detection of the probe location.

It is noted that the principles of touch screen in the above exemplary embodiments are demonstrated for a rectangular screen. While that is most common shape for most display screens, it need not be so. Touch screen may take other shapes depending upon the display device. One major advantage of the VCSEL array sources according to this invention is that the VCSEL arrays may be designed in other geometric shapes or random shapes. Accordingly, VCSEL array sources or VCSEL-detector arrays may be designed to suit other geometric shapes that are less practical in other prior art touch screen designs.

Touch Screen Systems Illuminated with VCSEL Array Sources (Indirect Coupling):

There are situations when it is not convenient or practical to locate the VCSEL illumination source at the lightguide or close to a display screen for directly coupling the light as described in the previous section. For example, in a large interactive display screen, a large size VCSEL array may be necessary to uniformly illuminate the display screen. A larger array of VCSEL according to this invention would require a large thermal management device which may not be very compact. Therefore, it is preferred to locate the VCSEL array source at some distance away from the touch screen.

This is achieved in many different ways for example, by using fiber or fiber bundles, waveguide or arrays of waveguides or micro-mirrors or arrays of micro-mirrors, and will be described shortly. The ability to configure VCSEL arrays and in particular, monolithically integrated VCSEL arrays with a very small array pitch particularly facilitates a high density of light beams using when routed using fiber/waveguide arrays or micro-mirror arrays. In the following sections, alternative apparatus and methods for providing illumination in the touch screen apparatus shown in FIGS. 1, 7-10, and 11(b) will be described. It is further noted that respective general description provided before for each of said embodiments also apply with alternative illumination methods as well and that description will not be repeated.

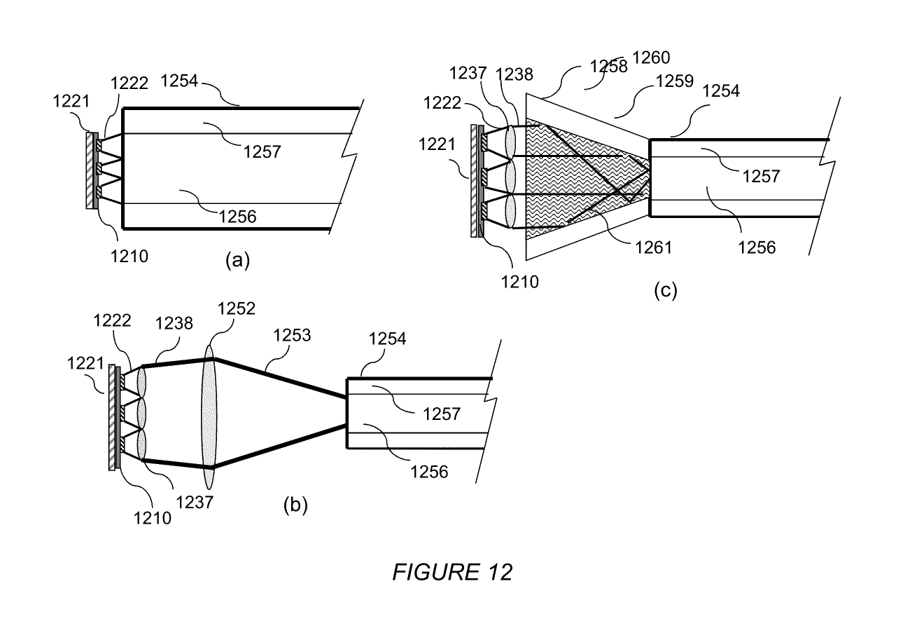

There are different ways known in the art to couple a fiber or a fiber pig-tail to a VCSEL. Preferred ways to couple light from a VCSEL and in particular, VCSEL array is shown in FIG. 12. The simplest method is to directly couple VCSEL emission to the fiber shown in FIG. 12(a). The method is particularly suitable when the diameter of the fiber core and its Numerical Aperture (NA) match the collective emission diameter including beam divergence of the VCSEL element for example, a VCSEL array in this figure. More specifically, a VCSEL array 1210 is placed in front of a fiber 1254 having a core 1256 and a cladding layer 1257. The distance between the VCSEL array and the fiber edge is adjusted such that the collective emission 1222 from the VCSEL array is directly incident upon the core 1256 of the fiber. It can be appreciated by those skilled in the art this method of coupling may also be adapted for single VCSEL device or for small size VCSEL array.

For larger arrays, the collective emission diameter including beam divergence may not match the fiber core diameter and/or NA. In FIG. 12(b) a different method of coupling VCSEL array to a fiber is schematically shown. In particular, collective emission 1222 from a VCSEL array 1210 is collimated using a microlens array 1237 placed at a pre-determined distance such that a highly collimated beam 1238 is generated. The highly collimated beam is focused using a lens 1252. The lens 1252 is selected such that the diameter of the focused beam 1253 is well matched with the core diameter of the core (1256) of the fiber 1254.

Another alternative coupling method is shown in FIG. 12(c) where an optical taper component is used to capture the collimated emission 1238 from the VCSEL array 1210. Similar to the arrangement described in reference with FIG. 12(b), a microlens array 1237 is used to collimate individual beams from the VCSEL array. The optical taper component 1258 comprises a core region cone of transparent medium 1259 surrounded by a clad layer 1260 of a lower index medium. The taper component is positioned in front of the fiber 1254 such that the cores of the fiber and taper component are substantially aligned.

The VCSEL element for example, the VCSEL array 1210 in this example, is aligned on the wider end of the taper such that the collimated beam 1238 enters the core of the taper. The radiation entering the core of the taper traverses the taper length by total internal reflection (shown as rays 1261) at the taper boundaries and is coupled to the core of the fiber 1256. While the methods are described with a microlens array 1237, it is optional for reducing divergence and improving brightness. Same method may be used without the microlens array. It can be appreciated that same methods are equally applicable for coupling light from a single VCSEL device or a smaller array comprising just a few VCSEL devices.

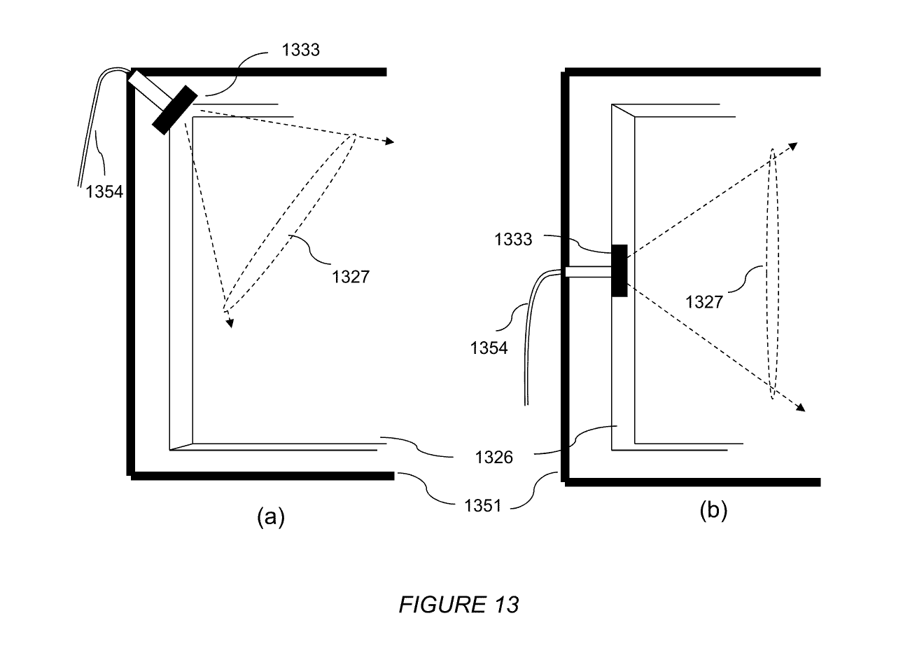

Referring now to FIG. 13, there it shows an alternative arrangement to illuminate a lightguide in a touch screen. The embodiments shown in FIGS. 13(a) and 13(b) are substantially similar to the embodiments described in reference with FIGS. 1 and 7, respectively, and respective general descriptions would apply here as well. That description would not be repeated for brevity. In general, the touch screen shown in this embodiment includes a touch panel 1326 to be placed in front of a display screen 1351, similar to the ones described in reference with FIGS. 1 and 7. The difference in the embodiment shown in FIGS. 1 and 7 and FIGS. 13(a) and 13(b) is in the light coupling arrangement.

More specifically, instead of coupling the VCSEL emission directly at a corner or at one edge of the lightguide as shown in FIGS. 1 and 7, respectively, light is routed through a fiber 1354 and coupled to the lightguide 1326 at a corner or at one of the edges of the lightguide (FIGS. 13(a) and 13(b)). An additional lens 1333 is placed in front of the fiber end to generate a highly divergent beam for uniformly illuminating the lightguide. Those skilled in the art will be able to appreciate that same method of routing the light from an illumination source using a fiber may be adapted for a touch screen that does not use a lightguide.

More specifically, the touch screen shown in FIGS. 13(a) and 13(b) may be adapted to function without the lightguide. Instead, the illumination through the fiber after being transmitted through the divergence lens 1333 may be projected directly over the display screen 1351, substantially in a similar fashion as described earlier in reference with FIG. 11(a). The touch screen in this variant embodiment functions similarly to the touch screen described in FIG. 11(a) and that description will not be repeated.

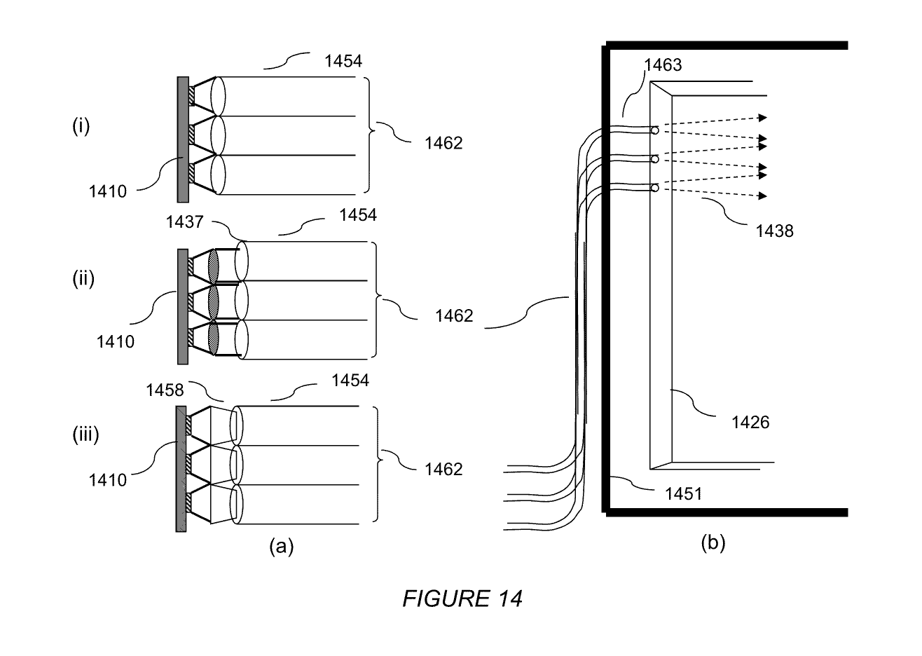

Referring now to touch screen systems described in reference with FIGS. 8, 9, 10 and 11b, the embodiments shown therein may be adapted for illuminating a lightguide (FIGS. 8, 9, and 10) or free space illumination over a display screen (FIG. 11b). It may be recalled that a plurality of collimated beams from a VCSEL array were coupled at one or more edges of a lightguide. Substantially similar illumination may be achieved by coupling light through a fiber bundle as shown in FIG. 14. A plurality of VCSEL beam emissions may be coupled to a fiber bundle as shown in FIG. 14(a). More specifically, three different coupling methods shown in (i), (ii), and (iii) correspond to fiber coupling methods described in reference with FIG. 12. It may be understood that any one method may be selected depending upon the requirement.

Referring now to FIG. 14(b), there it shows an arrangement to edge couple light to a lightguide in a touch screen. In particular, a fiber bundle 1462 comprising a plurality of fibers with the output ends 1463 are positioned in a linear array along one edge of the lightguide 1426. The coupling of light using a fiber bundle provides a plurality of collimated beams 1438 that illuminate the lightguide in substantially similar fashion as described in the embodiments shown in FIGS. 8, 9, 10 and 11(b) (for free space illumination over the display screen). An optional microlens array (not shown) aligned with the fiber ends may additionally be used to adjust the collimation properties of the output beams from the fiber ends.

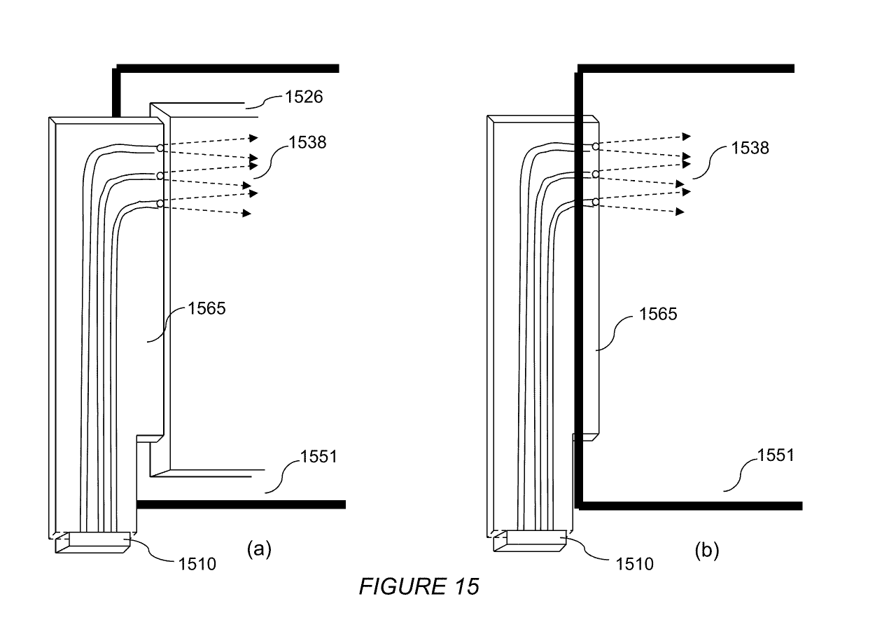

Alternative methods may be applied to couple light from VCSEL arrays to a lightguide using an array of waveguides. Exemplary arrangements for touch screen using a lightguide and a counterpart free-space projection over a display screen are shown in FIGS. 15(a) and 15(b), respectively. More specifically, in FIG. 15(a), a rigid waveguide array 1565 is positioned to couple light from a VCSEL array 1510 located on the other end of the rigid waveguide array, to one edge of the lightguide 1526. The waveguide array provides an array of beams 2038 into the lightguide substantially in a similar fashion as the fiber array described in reference with FIG. 14(b).

Light from the VCSEL array 1510 is coupled to the waveguide array using the methods described in FIGS. 12 and 14(a). In the arrangement shown in FIG. 15(b), the array of beams from the waveguide array 1565 is projected directly over the display screen 1551. Notably, this arrangement does not use a lightguide and functions substantially similar to a touch screen described in reference with FIG. 11(b). To improve uniformity, additional optical components (not shown) may be placed at appropriate locations.

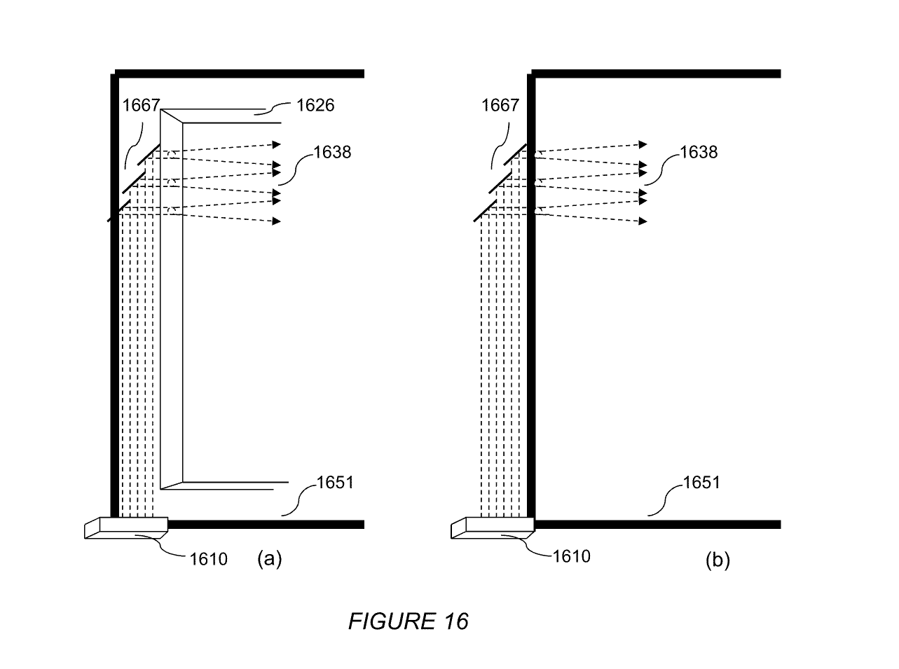

Another alternative method to couple light in a touch screen is to couple light using micro mirrors for example Micro-Electromechanical Mirrors (MEMs) as shown in an arrangement in FIG. 16. The method may be applied to couple light to a lightguide or free space projection of light over the display screen shown in FIGS. 16(a) and 16(b), respectively. More specifically, collimated light beams from the VCSEL array 1610 are reflected off of individual micro mirrors 1667 to direct each beam into the lightguide 1626 at the required position. It is preferable to use a microlens array in front of the VCSEL array for highly collimated beams. The same arrangement may also be employed for free-space light projection type touch screen shown in FIG. 16(b). The arrangement for providing parallel light beams to project a thin light sheet over the display screen 1651 is substantially similar to that described in reference with FIG. 11(b).

Although the invention has been described in detail with reference to some preferred embodiments, a complete framework of the invention is provided in various combinations and sub-combinations of these embodiments. Applications of the principles embodied in these descriptions would result in many design choices that will occur to those skilled in the art and may lead to large number of different illumination configurations using VCSELs and arrays of VCSELs and VCSEL-detector integrated arrays for application in touch screens, are implicitly covered within this broad framework. All such variations and modifications of the present invention are intended to be covered in the claims that follow.

What is claimed is:

1. A touch screen sensor system for a display screen, said sensor system comprising:
a transparent planar lightguide having a refractive index higher than the refractive index of the surrounding environment, and wherein the thickness of said lightguide is selected such that the display screen is visible through the lightguide;
at least one radiation source including a plurality of VCSELs optically coupled to the lightguide, wherein radiation from said radiation source transmitted through the lightguide is ordinarily confined within the plane of the lightguide;
at least one radiation sensor placed at one end of the lightguide to detect a portion of said radiation scattered out of the plane of the lightguide when said lightguide is touched on one surface by an object, such that the condition for radiation confinement is temporarily disturbed; and
a processor for processing one or more signals including an electrical signal generated in response to the scattered light to determine the location and direction of motion of the object.

2. The sensor system as in claim 1, wherein the lightguide is positioned externally over the display screen, and wherein radiation is coupled in the lightguide at one edge or one corner.

3. The sensor system as in claim 1 wherein the lightguide is integral to the display screen, and wherein radiation is coupled in the display screen at one edge or one corner.

4. The sensor system as in claim 1, wherein the plurality of VCSELs comprises an array, said array configuration is one selected from a group consisting of a linear array, a two-dimensional array, an array cluster, a sub-array and a combination thereof.

5. The sensor system as in claim 1, wherein the plurality of VCSELs comprises a monolithic array, said monolithic array configuration is one selected from a group consisting of a linear array, a two-dimensional array, an array cluster, a sub-array and a combination thereof.

6. The sensor system as in claim 1, wherein each one of the plurality of VCSELs includes a laser structure that is one selected from the group consisting of a two-mirror cavity, a three mirror integrated cavity, and a three mirror external cavity.

7. The sensor system as in claim 1, wherein the at least one radiation sensor comprises a camera positioned above the lightguide such that the location of the object is determined by imaging the radiation scattered by the object.

8. The sensor system as in claim 1, wherein the at least one radiation sensor comprises one or more detector placed at one edge of the lightguide, such that the location of the object is determined by detecting the loss in intensity of radiation confined in the lightguide, said loss in intensity arising due to the portion of the radiation being scattered out of the lightguide.

9. The sensor system as in claim 1, wherein the at least one radiation source generates a plurality of collimated beams, said plurality of beams are coupled along one edge of lightguide.

10. The sensor system as in claim 9, wherein the at least one radiation sensor comprises an array of detectors positioned at an edge opposite from said coupled plurality of beams, such that the location of the object is determined by detecting a loss in the intensity of radiation confined in the lightguide.

11. The sensor system as in claim 10, wherein the array of detectors is integrated with the plurality of VCSELs.

12. The sensor system as in claim 9, wherein the plurality of collimated beams is generated in a pre-determined timing sequence by operating the array with a pulse drive current.

13. The sensor system as in claim 12, wherein the at least one radiation sensor comprises an array of detectors positioned at an edge opposite from said coupled plurality of beams, and wherein the location of the object is determined by detecting a loss in the intensity of radiation confined in the lightguide in a time dependent sequence synchronized with the pre-determined timing pulse sequence.

14. The sensor system as in claim 1 further including an additional radiation source to couple additional radiation to the lightguide from a different direction for a more uniform illumination.

15. The sensor system as in claim 1 further including an additional radiation sensor to determine the location of the object from a different direction.

16. The sensor system as in claim 1, wherein a second flexible lightguide having a refractive index higher than the refractive index of the surrounding environment is disposed above the lightguide, such that the object touches the lightguide via the flexible waveguide.

17. The sensor system as in claim 1, wherein one or more optical component is positioned in front of the at least one radiation source for modifying the at least one radiation source beam to a desired shape, and wherein said optical components are selected from a group consisting of a converging lens, a diverging lens, an array of microlens and a combination thereof.

18. The sensor system as in claim 17, wherein the array of microlens is disposed integral to the plurality of the at least one radiation source.

19. The sensor system as in claim 1 further including an external component to couple radiation from the at least one radiation source to the lightguide, wherein said external component is one selected from a group consisting of a fiber bundle, a waveguide array, and a micro-mirror array.

20. A touch screen sensor system for a display screen, said sensor system comprising:
at least one radiation source including a plurality of VCSELs for generating a uniform thin sheet of radiation to be transmitted in free space over the display screen;
at least one radiation sensor placed at one end of the display screen to detect a portion of said radiation scattered when an object disrupts transmission of said radiation sheet; and
a processor for processing one or more signals including an electrical signal generated in response to the scattered light to determine the location and direction of motion of the object.

21. The sensor system as in claim 20, wherein the plurality of VCSELs comprises an array, said array configuration is one selected from a group consisting of a linear array, a two-dimensional array, an array cluster, a sub-array and a combination thereof.

22. The sensor system as in claim 20, wherein the plurality of VCSELs comprises a monolithic array, said monolithic array configuration is one selected from a group consisting of a linear array, a two-dimensional array, an array cluster, a sub-array and a combination thereof.

23. The sensor system as in claim 20, wherein each one of the plurality of VCSELs includes a laser structure that is one selected from the group consisting of a two-mirror cavity, a three mirror integrated cavity, and a three mirror external cavity.

24. The sensor system as in claim 20, wherein the at least one radiation source is positioned at one edge or one corner of the display screen.

25. The sensor system as in claim 20, wherein the at least one radiation sensor comprises a camera positioned above the display screen such that the location of the object is determined by imaging the radiation scattered by the object.

26. The sensor system as in claim 20, wherein the at least one radiation sensor comprises one or more detector placed at one edge of the display screen such that the location of the object is determined by detecting the loss in intensity of radiation.

27. The sensor system as in claim 20, wherein the at least one radiation source generates a plurality of collimated beams, said plurality of beams are projected in free space along one edge of display screen.

28. The sensor system as in claim 27, wherein the at least one radiation sensor comprises an array of detectors positioned at an edge opposite from said coupled plurality of beams, such that the location of the object is determined by detecting a loss in the intensity of radiation projected in free space over the display screen.

29. The sensor system as in claim 28, wherein the array of detectors is integrated with the plurality of VCSELs.

30. The sensor system as in claim 27, wherein the plurality of collimated beams is generated according to a pre-determined timing pulse sequence.

31. The sensor system as in claim 29, wherein the at least one radiation sensor comprises an array of detectors positioned at an edge opposite from said coupled plurality of beams, and wherein the location of the object is determined by detecting a loss in the intensity of radiation in a time dependent sequence synchronized with the pre-determined timing pulse sequence.

32. The sensor system as in claim 20, further including an additional radiation source to couple additional radiation to the lightguide from a different direction for a more uniform illumination.

33. The sensor system as in claim 20 further including an additional radiation sensor to determine the location of the object from a different direction.

34. The sensor system as in claim 20, wherein optical components are positioned in front of the at least one radiation source for modifying the at least one radiation source beam to a desired shape, and wherein said optical components are selected from a group consisting of a converging lens, a diverging lens, an array of microlens and a combination thereof.

35. The sensor system as in claim 34, wherein the array of microlens is disposed integral to the plurality of the at least one radiation source.

36. The sensor system as in claim 20 further including an external component coupled to the at least one radiation source for transmitting a uniform thin sheet of radiation in free space over the display screen, wherein said external component is one selected from a group consisting of a fiber bundle, a waveguide array, and a micro-mirror array.

37. A touch screen sensor system comprising:
a display screen configured as a lightguide;
at least one radiation source including a plurality of VCSELs optically coupled to said lightguide, wherein radiation from said radiation source transmitted through said lightguide is ordinarily confined within the plane of said lightguide;
at least one radiation sensor placed at one end of said lightguide to detect a portion of said radiation scattered out of the plane of said lightguide when said lightguide is touched on one surface by an object, such that the condition for radiation confinement is temporarily disturbed; and
a processor for processing one or more signals including an electrical signal generated in response to the scattered light to determine the location and direction of motion of the object.

38. The sensor system as in claim 37, wherein radiation is coupled in the lightguide at one edge or one corner.

39. The sensor system as in claim 37, wherein the at least one radiation sensor comprises a camera positioned above said lightguide such that the location of the object is determined by imaging the radiation scattered by the object.

40. The sensor system as in claim 37, wherein the at least one radiation sensor comprises one or more detector placed at one edge of the lightguide, such that the location of the object is determined by detecting the loss in intensity of radiation confined in said lightguide, said loss in intensity arising due to the portion of the radiation being scattered out of said lightguide.
